(19) United States
(12) Patent Application Publication
(10) Pub. No.: US 2015/0088734 A1
(43) Pub. Date: Mar. 26, 2015

(54) WIRELESS UTILITY METER READING SYSTEM AND METHOD

(71) Applicant: MASTERCARD INTERNATIONAL INCORPORATED, Purchase, NY (US)

(72) Inventors: Mary Lesbirel, Holmdel, NJ (US); Misha Ghosh, Charlotte, NC (US)

(73) Assignee: MASTERCARD INTERNATIONAL INCORPORATED, Purchase, NY (US)

(21) Appl. No.: 14/032,559

(22) Filed: Sep. 20, 2013

(51) Int. Cl. G06Q 20/14; G06Q 30/04

(52) U.S. Cl. CPC G06Q 20/145; G06Q 30/04
USPC 705/40

(57) ABSTRACT

A wireless meter reading system and method are provided to facilitate billing a consumer for utility usage. The method comprises providing a camera or imaging device optionally coupled to a utility meter at a consumer site. The camera or imaging device operates to provide one or more wireless meter reading images of the utility meter from time to time. The one or more wireless meter reading images comprise utility usage data and identifying data of the utility meter. The one or more wireless meter reading images are transmitted to the utility provider. The utility consumer receives from the utility provider a billing statement for utility usage at the consumer site for a defined time period. The billing statement is based on the one or more wireless meter reading images transmitted to the utility provider.

### RELATED APPLICATIONS

This application is related to U.S. patent application Ser. No. ______ (0009340USU), filed on an even date herewith, which is incorporated herein by reference in its entirety.

### BACKGROUND OF THE DISCLOSURE

1. Field of the Disclosure

This disclosure relates to a wireless utility meter reading system and method. More particularly, this disclosure relates to a camera or imaging device that wirelessly communicates utility meter image data to a central location or utility provider. The utility meter image data can be utilized by the utility provider or its billing agent to determine utility usage and manage billing.

2. Description of the Related Art

Utility meters are used in many settings to monitor utility usage of a location (e.g., residence, commercial building, etc.) for natural gas, water, and/or electric. Typically, the utility supplier or its agent hires an individual, e.g., a meter reader, to travel to the various locations, view the meters, and record the meter readings. The meter reader provides that information back to the utility supplier or agent, so that their server can determine utility usage and manage billings, such as billing the customer for the usage.

The costs involved in having a meter reader travel to the various customer locations to take the meter reading can be excessive. Moreover, in some situations, the meter may be located inside of a structure which is not always readily accessible to the meter reader, thus hampering the meter reader and adding delay and further costs. In addition, the meter-readers may be subject to dog bites, human attack, or other dangers.

The field of remote sensing is growing rapidly. Remote sensing may include capturing visible light images, temperature, vibrations, seismic, infrared images, chemical or acoustic data. The remote data is either stored locally for later collection, or is transmitted via a wired or wireless connection to a data collection point. However, the use of remote imagers has been limited to applications where the remote camera has a stable power source, such as connection to a utility grid, or where the camera system can be conveniently accessed to change or charge its battery. Accordingly, the applications for remote imaging have been limited.

One application that could benefit from remote sensing is a remote utility meter reader. Meters, such as gas, electric, water, or other utility meters, are attached to nearly every home or business, and are often manually read every month by a meter reader. As indicated above, this is an expensive and time consuming process, and can expose meter readers to dangers. Due to the high cost of using human readers, some utilities use estimated bills. With an estimated bill, the utility actually reads the meter only a limited number of times per year, and based on historical records, estimates bills for the months when no reading is taken. At each reading cycle, there is a true-up, where the utility credits for any over-charge, or a larger bill to make up for underpayments. Either way, the estimated bills are a stop-gap so the utility can save money, and often leads to great consumer dissatisfaction.

Some new utility meters are being installed that have wired or wireless communication of usage data to the utility. These meters directly address the problems raised above, and in the long term, may be a satisfactory solution. However, these meters are quite expensive, and there are millions of legacy meters installed. It will take many years, if not longer, to replace and update all these meters. To date, there is no practical way to automatically read these meters.

For the foregoing reasons, given the limitations of the above-mentioned systems, an improved wireless meter reading system is desirable.

The present disclosure provides many advantages, which shall become apparent as described below.

### SUMMARY OF THE DISCLOSURE

This disclosure provides a wireless utility meter reading system and method.

Also, this disclosure provides a camera or imaging device that wirelessly communicates utility meter image data to a central location or utility provider. The utility meter image data can be utilized by the utility provider or its billing agent to determine utility usage and manage billing.

This disclosure provides a method of billing a consumer for utility usage. The method comprises providing a camera or imaging device optionally coupled to a utility meter at a consumer site. The camera or imaging device operates to provide one or more wireless meter reading images of the utility meter from time to time. The one or more wireless meter reading images comprise utility usage data and identifying data of the utility meter. The one or more wireless meter reading images are transmitted to the utility provider. The utility consumer receives from the utility provider a billing statement for utility usage at the consumer site for a defined time period. The billing statement is based on the one or more wireless meter reading images transmitted to the utility provider.

Also, this disclosure provides a method that involves retrieving, from one or more databases, a first set of information including billing activities attributable to a utility provider and payment activities attributable to one or more utility consumers; and retrieving, from one or more databases, a second set of information including billing activities attributable to a financial transaction processing entity and purchasing and payment activities attributable to the one or more utility consumers. The first set of information and the second set of information are analyzed to identify one or more correlations between utility usage and utility consumers. One or more predictive models are generated based at least in part on the one or more correlations.

The method of this disclosure further comprises trading or investing in weather derivatives based on the one or more predictive models. The trading or investing in weather derivatives based on the one or more predictive models is part of a risk management strategy to reduce risk associated with adverse or unexpected weather conditions.

Further, the method of this disclosure comprises identifying activities and characteristics attributable to the one or more utility consumers based on the one or more predictive models. The activities and characteristics include, for example, energy conservation, water conservation, green practices, and/or sustainable lifestyle practices.

This disclosure also provides a wireless meter reading system that comprises: (a) at least one utility meter having a housing and a face; (b) at least one camera or imaging device optionally coupled to the at least one utility meter, wherein the at least one camera or imaging device operates to provide one or more wireless meter reading images of the at least one utility meter from time to time, and wherein the one or more wireless meter reading images comprise utility usage data and identifying data of the at least one utility meter; (c) a power source coupled to the at least one camera or imaging device; (d) a communication device for wirelessly receiving the meter reading images from the at least one camera or imaging device; and (e) a wide area connection with the communication device for communicating the meter reading images to a central location.

This disclosure further provides a system that comprises one or more databases configured to store a first set of information including billing activities attributable to a utility provider and payment activities attributable to one or more utility consumers; one or more databases configured to store a second set of information including billing activities attributable to a financial transaction processing entity and purchasing and payment activities attributable to the one or more utility consumers; and a processor. The processor is configured to: analyze the first set of information and the second set of information to identify one or more correlations between utility usage and utility consumers; and generate one or more predictive models based at least in part on the one or more correlations.

This disclosure yet further provides a camera or imaging device configured to read a utility meter. The camera or imaging device comprises a housing; and a lens, a memory, a processor, a power source, and a wireless communication transceiver associated with the housing. The camera or imaging device is adapted to be connected to the utility meter.

Advantageously, the camera or imaging devices of the present disclosure may be attached to legacy meters, enabling very efficient and accurate remote meter reading.

Further objects, features and advantages of the present disclosure will be understood by reference to the following drawings and detailed description.

### BRIEF DESCRIPTION OF THE DRAWINGS

FIG. 1 is a block diagram illustrating a high-level view of system architecture of a financial transaction processing system in accordance with exemplary embodiments.

FIG. 2 is a schematic diagram of an exemplary mobile computing device useful for taking digital images of a utility meter in accordance with the principles of the present disclosure.

FIG. 3 is a diagrammatic illustration of an individual, such as a utility customer, using the mobile computing device of FIG. 2 to take a digital picture of a utility meter in accordance with the principles of the present disclosure.

FIG. 4 is an enlarged view of a portion of FIG. 3 showing an exemplary utility meter (analog).

FIG. 5A is a flow chart showing correction of energy meter misreads in an exemplary embodiment the present disclosure.

FIG. 5B is a flow chart showing a camera device for capturing and sending energy meter images to energy companies in an exemplary embodiment the present disclosure.

FIG. 6A is a perspective view of a portion of a wireless meter reading system according to the present disclosure.

FIG. 6B is a perspective view of a portion of the wireless-meter reading system of FIG. 6 showing a side view of the system.

FIG. 7 is a block diagram of a meter reading system in accordance with the present disclosure.

FIG. 8 is a block diagram of a meter reading system in accordance with the present disclosure.

FIG. 9 is a block diagram of a meter reading system in accordance with the present disclosure.

FIG. 10 is a flowchart of a method for meter reading in accordance with the present disclosure.

FIG. 11 is a flow chart illustrating a method for generating predictive models in accordance with exemplary embodiments of this disclosure.

### DESCRIPTION OF THE EMBODIMENTS

Embodiments of the present disclosure can now be described more fully hereinafter with reference to the accompanying drawings, in which some, but not all, embodiments of the disclosure are shown. Indeed, the disclosure can be embodied in many different forms and should not be construed as limited to the embodiments set forth herein; rather, these embodiments are provided so that this disclosure may satisfy applicable legal requirements. Like numbers refer to like elements throughout.

As used herein, entities can include one or more persons, organizations, businesses, institutions and/or other entities, including but not limited to, financial institutions, and services providers, that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

For purposes of this disclosure, the term “consumer site” is interchangeable with the term “customer site”, and the term “utility company site” is interchangeable with the term “utility provider site”. Furthermore, the terms “customer” and “consumer” are interchangeable, as are the terms “utility company” and “utility provider”. The term “network hub” is interchangeable with “internet network”. The term “utility customer” is interchangeable with the term “utility consumer”.

The present disclosure facilitates easy capture of utility meter readings by which to simply, economically, and automatically obtain accurate utility meter readings without the disadvantages encountered with prior meter reading methods. To that end, and in accordance with one embodiment of the present disclosure, a customer or other individual takes a digital picture of the utility meter, specifically including at least the dials thereof, such as with a digital camera. The meter reading can then be transmitted to the utility provider, and utilized by the utility provider or its billing agent to determine utility usage and manage billing.

In particularly advantageous embodiments of the disclosure, the digital picture may be received through a digital camera forming part of a mobile computing device such as a smart phone. The meter reading image obtained with the smart phone can be sent, using the communication facility of the smart phone, to a server associated with a utility provider or its agent to determine utility usage and manage billings.

While one embodiment of the present disclosure is particularly advantageously applied to and with a smart phone, other embodiments do not necessarily require or involve a smart phone. For example, other mobile computing devices generally considered to be hand-held and having digital imaging and communication capability may be used, such as tablet computers, netbook computers, or the like. Similarly, the digital image can be captured by a stand-alone digital camera, as described herein, and then transferred to a separate computer, either wirelessly or with a cable. The separate computer could be a customer's computer where the image is processed and the results communicated to the server. Or the computer could be the server, which receives the image from the digital camera or from an intermediary computer such as a customer's computer which itself had received the digital image.

Most individuals have digital cameras and computers equipped for internet communication. Many also have mobile computing devices, such as smart phones. Thus, deployment and/or implementation of the disclosure can be readily and economically accomplished to automatically develop and provide customer supplied meter readings, but in a fashion that is so easy to use that compliance is far more likely, with little cost and with significantly less risk of error than encountered with prior meter reading methods. For example, with the present disclosure, the customer does not have to determine the respective positions of the dial indicators, does not have to fill out and mail a card, and does not have to call and report the dial indicator positions verbally. Instead, in an embodiment, the customer need merely aim the digital camera at the meter dials and takes a picture thereof in conventional manner. As a consequence, the drawbacks of prior meter reading methods are overcome. More particularly, the foregoing can be readily accomplished without the costs of sending meter readers to the consumer locations, and without the delays, costs, and errors of approaches which involve the consumer manually reading the dials, and completing mailings or voice call-ins. Yet, the consumer can take the digital image and cause or permit it, or the meter reading, as appropriate, to be sent electronically to the server of the utility provider or its billing agent, thereby reducing costs and errors. Nonetheless, in some situations, the utility supplier or its agent may find it beneficial to provide the meter reader(s) with an appropriate programmed mobile computing device to facilitate their meter reading tasks.

In another embodiment, a wireless meter reading system is provided that includes a utility meter having a housing and a face and a camera or imaging device located in the housing. The camera or imaging device is adapted to read and convert data located on a portion of the face to wirelessly transmittable data. A power source coupled to the camera or imaging device permits continuous and instantaneous capture of the wirelessly transmittable data from the face of the utility meter by the camera or imaging device. A communication device provided for wirelessly receiving and transmitting data between a consumer site and a utility provider site facilitates monitoring of the face of the utility meter by the consumer site and by the utility provider site.

The wireless meter reading system is at least one meter having a housing, with a camera or imaging device located in the housing of the at least one meter. The camera or imaging device is preferably capable of capturing multiple images of a face of the meter having usage data and unique identifying data pertaining to the meter. The camera or imaging device (or a module located in the housing of the meter) is adapted to transmit the captured images wirelessly to at least one of a satellite, a cell phone network and a combination router/cable. The captured images are relayed to a network hub wirelessly. The captured images are then relayed to both at least one consumer and at least one utility provider, where the visual images of the meter are viewed.

According to this embodiment, the improved wireless meter reading system enables all parties with an interest in the utility usage to obtain real-time information. The consumer benefits from this arrangement by being able to observe the meter and optimize utility usage. The utility provider benefits by reducing employee costs, knowing when the meter is malfunctioning and optimizing future utility usage needs by observing consumption of the utility, and providing feedback to the consumer about peak usage and how the consumer may be able to reduce utility usage costs.

In accordance with one embodiment of this disclosure, a wireless meter reading system is disclosed. The system having at least one consumer site and at least one utility provider site, comprises in combination (a) at least one utility meter having a housing and a face; (b) at least one camera or imaging device coupled to the housing, the at least one camera or imaging device adapted to read and convert data located on a portion of the face to wirelessly transmittable data; (c) a power source coupled to the camera or imaging device for powering the at least one camera or imaging device; and (d) a communication device for wirelessly receiving and transmitting data between the at least one consumer site and the at least one utility provider site to facilitate monitoring of the face of the at least one utility meter by the at least one consumer site and by the at least one utility provider site.

In yet another embodiment, a system and method is provided for automatically reading meters, such as utility meters. A camera or imaging unit is attached to or otherwise associated with an existing utility meter. From time to time, either automatically, or upon wireless command, the camera unit takes an image of the utility meter's readings, and communicates wirelessly the image or image data, to a local area receiver. The images can be transmitted immediately, or stored for later transmission, depending on the network protocol. The camera or imaging unit is battery powered, and operates communication protocols that enable extended operational life. These protocols allow for the camera's radio and processor to be turned on only when necessary, and then for only brief periods of time. At most times, the camera is in a power-conserving sleep mode. Multiple camera units may be arranged to communicate utility meter image data to the local area receiver, either using asynchronous or synchronous processes. The meter image data is communicated from the receiver to a central office using a wide area connection, where the image data is used for determining the utility meter reading. In one example, the image may be included with a utility bill as confirmed evidence of the current meter reading.

Advantageously, the camera units of the present disclosure may be attached to legacy meters, enabling very efficient and accurate remote meter reading. Because of the low-power protocols and structures in the camera units, in normal use the camera units will operate autonomously for up to several years. Accordingly, meter reading can be made more efficient and safe, and fully automated remote meter reading is possible, even with older legacy meters. This allows the cost, accuracy, and safety benefits of remote meter readings to be used on existing meters. In addition, frequent readings, even several times a day, are conveniently possible. This enables utility companies to track hourly usage or even charge per time of use (especially for electricity). In addition, simple imaging DSP (digital signal processing) can be applied to the meter image, and used to read the meter by the utility. This information may then be used to compare to previous readings by a computer, and create a bill without human intervention thus improving reliability and productivity. In one example, the bill may even include an image of the final meter reading.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium may be integral to the processor. Further, in some embodiments, the processor and the storage medium can reside in an Application Specific Integrated Circuit (ASIC). In the alternative, the processor and the storage medium can reside as discrete components in a computing device.

Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It can be understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the disclosure.

Thus, apparatus, systems, methods and computer program products are herein disclosed to generate predictive models. Embodiments of the present disclosure will leverage the information available to identify data that is predictive of, for example, weather trends. Opportunities, including trading or investing in weather derivatives, are available using the predictive models. Embodiments of the present disclosure will leverage the information available to identify data that is indicative of a customer's activities and characteristics and to predict consumer behavior and intent based on those activities and characteristics, e.g., energy conservation, water conservation, green practices (e.g., reducing carbon footprints, recycling, etc.) and sustainable lifestyle practices of customers, and the like. By identifying and analyzing consumer activities and characteristics, predictive models can be generated and one can offer products and services that are relevant to the consumer's needs.

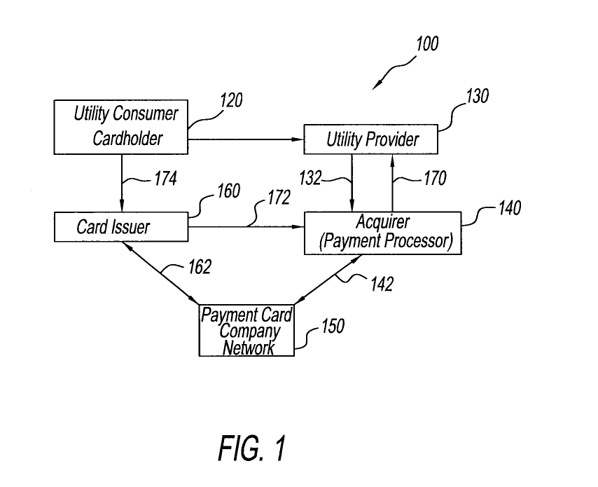

Referring to the drawings and, in particular, FIG. 1, there is shown a four party payment (credit, debit or other) card system generally represented by reference numeral 100. In card system 100, utility consumer card holder 120 submits the payment card to the utility provider 130. The utility provider's point of sale (POS) device communicates 132 with his acquiring bank or acquirer 140, which acts as a payment processor. The acquirer 140 initiates, at 142, the transaction on the payment card company network 150. The payment card company network 150 (that includes the financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the utility provider 130. Thereafter, seconds later, the utility consumer card holder 120 completes the purchase and receives a receipt.

The account of the utility provider 130 is credited, via 170, by the acquirer 140. The card issuer 160 pays, via 172, the acquirer 140. Eventually, the utility consumer card holder 120 pays, via 174, the card issuer 160.

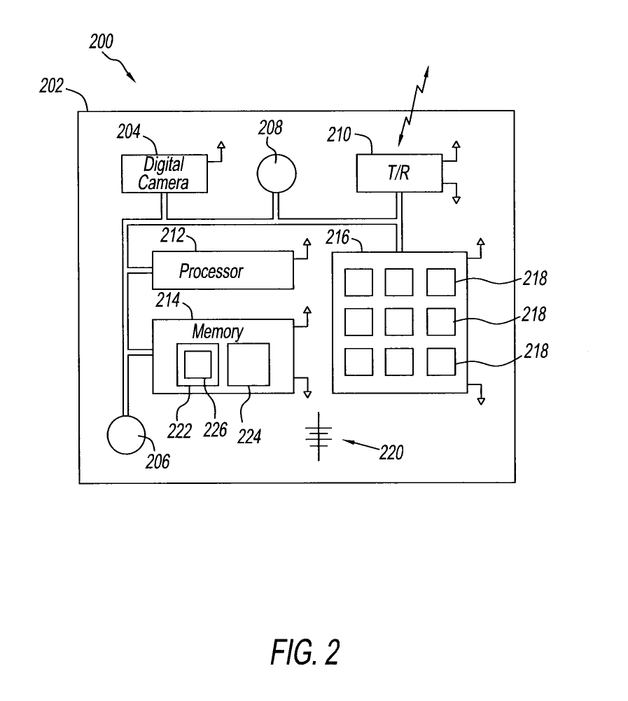

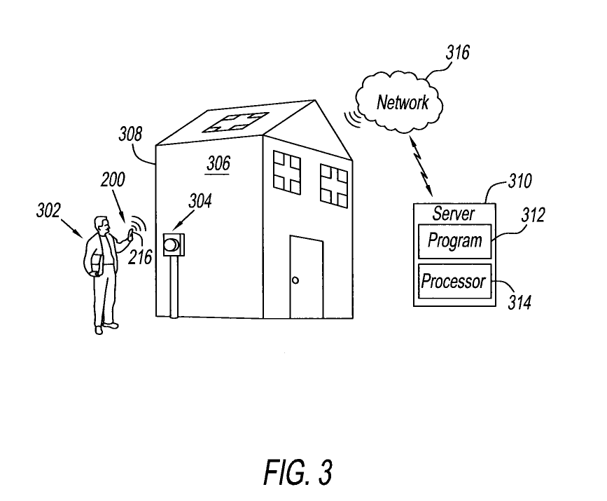

With reference to FIG. 2, there is shown a schematic view of an exemplary mobile computing device 200 which may advantageously be adapted or used with the present disclosure. Mobile computing device 200 has a housing 202 sized to easily held in one hand by an individual 302 (FIG. 3), such as a utility customer or someone acting on the customer's behalf, or a meter reader. One particularly advantageous type of mobile computing device 200 is a smart phone, such as an iPhone or a Droid-based cellular phone by way of examples, the housing 202 of which is sized to be hand-held so as to be easily carried in or with one hand. Mobile computing device 200 will thus be referenced herein as a smart phone, although it will be understood that the mobile computing device 200 could be some other comparable, hand-held device, such as a tablet computer an example of which is the iPad, a netbook computer, or the like.

Housing 202 supports the various electronic components of the smart phone 200 operatively interconnected by one or more busses. These components include a digital camera 204, a microphone 206, a speaker 208, a transceiver (T/R) section 210, a processor 212, a memory 214, and a display/user interface 216, all as may be standard in a smart phone 200. Housing 202 may also support a battery 220, which may be rechargeable, to provide power to the various electrical components of smart phone 200 such that the smart phone 200 is mobile and self-contained for use. The display/user interface 216 provides images to the user 302, such as icons or other virtual buttons as at 218, or digital images sent to the smart phone 200, or as captured by the digital camera 204 thereof. Similarly, the memory 214 includes various operating programs 222 for operation of the smart phone 200 and a data storage 224. Smart phone 200 may, through its T/R section 210, communicate over a communication network 316 (FIG. 3). The communication network 316 may provided by a cellular provider, examples of which include Verizon, Sprint, and AT&T. The communication network 316 can be, by way of further example, a Code Division Multiple Access (CDMA) or Global System for Mobile Communications (GSM) network, and may also include an IEEE 802.11 (WiFi) network as all or part thereof. Data may be stored in a data storage 224 of memory 214 by which to facilitate storage and communication of data such as digital images taken by camera 204 or messages, texts, images, and/or web pages received by the smart phone 200 over the communication network 316.

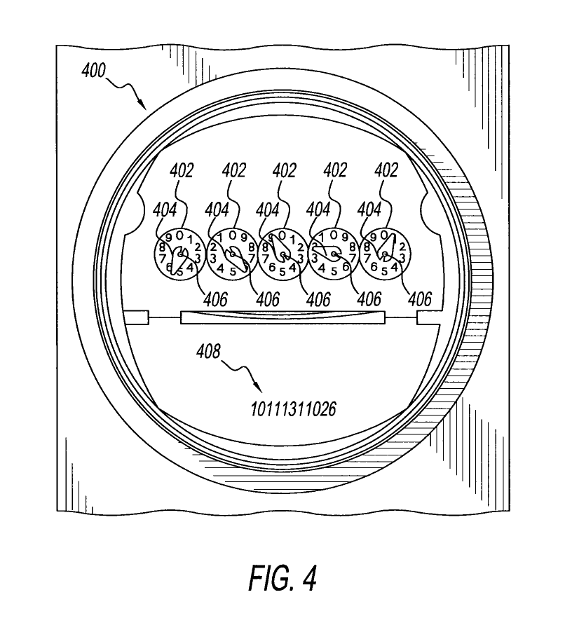

As seen in FIG. 3, a utility meter 304 may be mounted to a wall 306 of a house or other structure 308 to monitor usage of a utility of that structure 308. With further reference to FIG. 4, which is an enlarged view of a portion of FIG. 3, meter 400 includes a plurality of dials 402 each having a dial indicator 404 which rotates, such as clockwise or counterclockwise (they may all rotate in the same direction, or some may rotate in one direction while others rotate in the other direction) driven by an axial pin 406 of the dial 402 as the utility being metered is used. The angular relationship of each dial indicator 404 correlates to the amount of utility consumed, such as by pointing to respective numbers about the dial 402. The meter 400 typically also includes identifying indicia, such as a serial number or the like as at 408.

The individual 302 holds the smart phone 200 so as to aim the digital camera 204 thereof at the dials 402. An image of what is in the view of the digital camera 204 will typically show in the display/user interface 216. The individual 302 desirably positions the smart phone 200 such that the dials 402 are aligned horizontally across the display/user interface 216 and visible within a bracketed image area (not shown). The user may be prompted by a message on the display/user interface 216 to either tap thereon to take a picture or swipe thereacross to cancel. When the picture is taken, a digital image or picture of the meter 400 as seen in FIG. 4, including the dials 402 will then typically be stored in the data store 224. The digital image is considered received by the processor 212 of the smart phone 200 when it is taken.

Advantageously, the image includes all of the dials 402 with the respective dial indicators 404 showing their respective angular relationships within each dial 402. The digital image also advantageously, but need not necessarily, includes the meter identifying information 408. When the picture is taken, all or a portion thereof is also typically displayed on display/user interface 216.

The meter reading (with or without the image) may be transmitted via the communication network 316 from the smart phone 200 to a server 310, which is used by or on behalf of a utility provider or supplier to determine utility usage, manage billings and/or for other purposes as considered necessary by the utility supplier or its agents. As will be readily understood, the server 310 may communicate with the communication network 316 directly or via other connections, such as telephone lines, other cable connections, the internet, and/or cellular or other wireless connections.

The server 310 may contain a program 312 which will cause the processor 314 of the server to analyze the received digital image and generate the meter reading directly. Where the smart phone 200 transmits both the digital image and the meter reading, the processor 314 of the server may analyze the digital image to compare it to the received meter reading as a reliability check. The digital image may be evaluated at or by the server 310 in respect of the meter identifying information 408 to confirm that the digital image and/or meter reading are from an expected meter 400.

While a smart phone 200 is a particularly advantageous implementation of the present disclosure, other mobile computing devices can be employed. The digital image can be captured by a stand-alone digital camera, and then transferred to a separate computer, either wirelessly or with a cable. The separate computer could be a customer's computer where the image is communicated to the server 310. Or the computer could be the server 310, which receives the image from the digital camera or from an intermediary computer such as a customer's computer which itself had received the digital image as described herein. In any of these situations, the processor of the computer (whether of the mobile computing device, the customer's computer, and/or the server) may be programmed to analyze the received image.

Additionally, while the present disclosure advantageously facilitates easy capture of meter readings by which to simply, economically, and automatically obtain accurate customer-supplied meter readings without the disadvantages encountered with present approaches, meter readers may also take advantage of the present disclosure, such as with an appropriate programmed mobile computing device 200. Similarly, while the disclosure has been described in the context of a fully functioning smart phone 200, it will be appreciated that the various embodiments of the programming for implementing the disclosure are capable of being distributed as a program product in a variety of forms, and that the disclosure applies equally regardless of the particular type of computer readable media used to actually carry out the distribution. Examples of computer readable media include but are not limited to physical and tangible recordable type media such as volatile and nonvolatile memory devices, floppy and other removable disks, hard disk drives, optical disks (e.g., CD-ROM's, DVD's, etc.), among others.

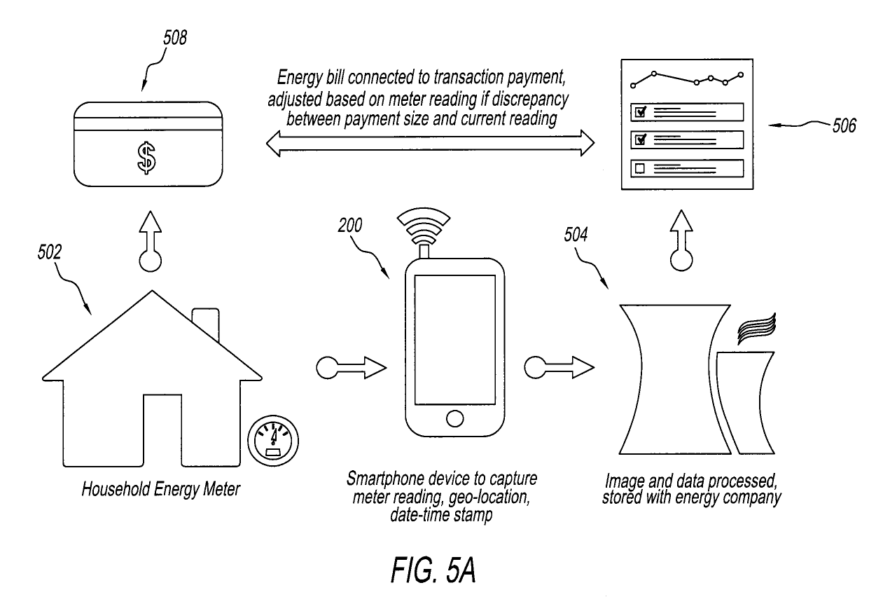

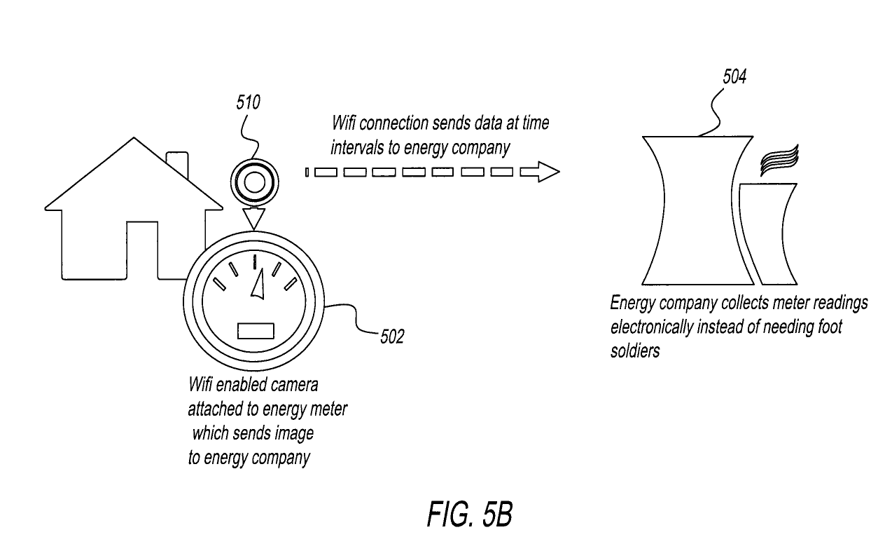

Referring to FIG. 5A, a household energy meter 502 is read at a particular date and time. A smartphone 200 is used to capture the meter reading, geolocation and date-time stamp. The meter reading image(s) is wirelessly transmitted to an energy provider or supplier 504 where the image(s) and data are processed and stored. An energy billing statement 506 is sent to a consumer who pays his or her energy bill with a payment card 508. The energy billing statement 506 is thereby connected to the payment card transaction and, if a discrepancy exists between the billing statement and utility usage at the consumer site for a defined time period, the consumer can request the utility provider to adjust the billing statement to accurately reflect the utility usage at the consumer site for the defined time period, based on the wireless meter reading images transmitted to the utility provider.

Referring to FIG. 5B, a household energy meter 502 is read at a particular date and time. A camera device 510 is used to capture the meter reading, geolocation and date-time stamp. The camera device 510 is connected to the energy meter 502 and is WiFi enabled to transmit images to the energy company 504. The WiFi connection sends image data at time intervals to the energy company 504. The meter reading image(s) is wirelessly transmitted to an energy provider or supplier 504 where the image(s) and data are processed and stored. In accordance with this embodiment, the energy provider or supplier 504 is able to collect meter readings electronically without the need of meter readers.

In another embodiment of this disclosure, the camera or imaging device is attached to or otherwise coupled to the utility meter. This embodiment provides a wireless meter reading system in which no meter reader is needed.

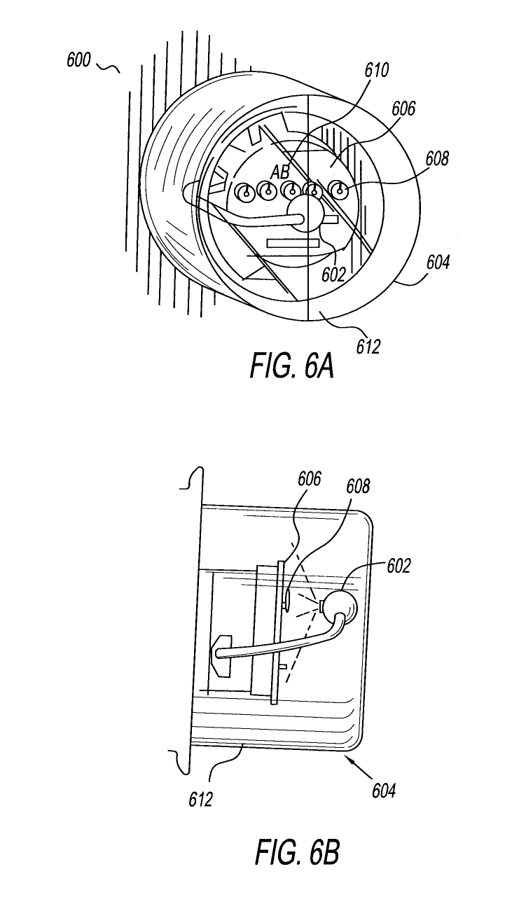

According to FIG. 6A, a portion of a wireless meter reading system 600 comprises at least one utility meter 604 (shown in FIG. 6A as an electric utility meter 604) having a housing 612 and including a face 606. The housing 612 preferably comprises a substantially transparent durable polymer. The face 606 of the at least one utility meter 604 comprises at least utility usage data 608 (shown in FIG. 6A as a plurality of numeric dials 608) of the at least one utility meter 604. The movement of each one of the plurality of dials 608 indicates (counts) utility usage. The face 606 of the utility meter 604 displays identifying data 610. The identifying data 610 uniquely identifies each utility meter 604 that corresponds to each customer (or consumer) site. A portion of the wireless meter reading system 600 further comprises at least one camera or imaging device 602.

The camera or imaging device 602 is adapted to read and convert the data (the utility usage data 608 and the identifying data 610) located on a portion of the face 606 to wirelessly transmittable data. Conversion methods include various compression schemes for transmitting digital data more easily, including Joint Photographic Experts Group (“jpeg”) formats and the like. The camera or imaging device 602 is located in the housing 612 of the utility meter 604. The camera or imaging device 602 may be at least one of a digital camera, a web camera, an electronic eye, a laser, a digitally counting electronic chip, a scanner, a bar code reader or the like. The listing of the above is not to be construed as a limitation of the scope of the present disclosure. The camera or imaging device 602 can comprise a charge-coupled device (CCD) sensor having at least about 0.03 mega-pixel resolution and the camera or imaging device 602 captures visual images through a small fixed lens.

The camera or imaging device 602 converts the visual images to electric pulses and either temporarily saves these electric pulse images in on-board memory within the at least one camera or imaging device 602 for subsequent wireless transmission, or immediately transmits these electric pulse images wirelessly. Each one of the electric pulse images can have at least a resolution of 160×120 pixels. The camera or imaging device 602 can be a still digital camera or a digital camera capable of continuous operation such as a digital movie camera operating at a speed of at least 15 frames per second. An aperture of the lens of the camera or imaging device 602 has both auto-focus and auto light settings, thereby taking into account prevailing environmental conditions. If the camera or imaging device 602 is a digital camera, a digital shutter of the camera or imaging device 602 controls the operation of the camera or imaging device 602.

A portion of the wireless meter reading system 600 may further comprise the utility meter 604 having an alarm (shown as a portion of the camera or imaging device 602 coupled to the housing 612) adapted to alert the utility provider (or utility company) site when the utility meter 604 is inoperable and requires repair. A portion of the wireless meter reading system 600 may further comprise a light source (not shown) located in the housing 612 of the utility meter 602. The light source may be activated under low light conditions where the auto light setting may be inadequate, thereby facilitating optical capture of wirelessly transmittable data (utility usage data 608 and identifying data 610 converted into electronic form) from the face 606 of the utility meter 602.

The housing 612 of the utility meter 604 may further have at least one wireless transfer module located in the housing 612. Alternatively, the camera or imaging device 602 may comprise the wireless transfer module (not shown). Well-known wireless technologies having wireless transfer modules include UWB, 802.11g, 802.11a, 802.11b, WLAN, Wi-Fi®, AirPort, Infrared, Bluetooth® and ZIGBEE®, and the like. However, wireless technology is a rapidly developing technical field and the above listing of wireless technologies should not be construed as a limitation of the current disclosure. With the wireless transfer module, e-mail may be sent wirelessly to a (intranet or internet) network hub by a communication device provided for wirelessly receiving and transmitting data. The network hub is controlled by the at least one utility company (or provider) site, and e-mail may be distributed to both the customer (or consumer) site and the utility company (or utility provider) site. The network hub comprises a server (not shown) of a central processing unit preferably controlled by the utility provider site. The server of the network hub wirelessly relays data to at least one local CPU having an antenna located at the at least one utility company site. The server of the network hub also wirelessly relays data to at least one local central processing unit (CPU) having an antenna located at the at least one customer site.

The communication device comprises a combination of a router/modem. An antenna of the communication device for wirelessly receiving and transmitting couples the combination of the router/modem wirelessly to both the camera or imaging device 602 and to the network hub. The network hub relays visual images of the face 606 of the utility meter 604 from the camera or imaging device 602 to the customer (or consumer site) and to the one utility company (or utility provider) site. The network hub facilitates e-mail transmissions between the utility company (or utility provider) site and the customer (or consumer site).

Alternatively, the communication device may be at least one of a satellite and a cell phone network, and the like. The communication device is wirelessly coupled to the camera or imaging device 602 (such as a wireless cell phone). It is understood that when the communication device is coupled to a wireless cell phone, the wireless cell phone further comprises at least a camera or imaging device 602 such as a digital camera, and the like. The wireless cell phone may be programmed to respond to transmissions from both the customer site and the utility company site. Each one of the satellite and the cell phone network is adapted to relay data from the camera or imaging device 602 located in the housing 612 of the utility meter 604 to the consumer site and to the utility provider site.

Referring to FIG. 6B, a side view of a portion of the wireless meter reading system 600 includes the camera or imaging device 602 positioned in the housing 612 of the electric utility meter 604 of FIG. 6A. The camera or imaging device 602 is adapted to read the face 606, having the utility usage data 608 and the identifying data 610 (not shown in FIG. 6B), located thereon of the electric utility meter 604.

In an embodiment, the utility provider or consumer can monitor the face 606 of the utility meter 604 of each consumer and predict future utility usage of each consumer. This will enable the utility provider to improve planning for utility expansion. The utility provider is further enabled to improve planning of peak usage times of the utility usage of each consumer to allocate costs of the utility usage to each consumer during peak usage times efficiently.

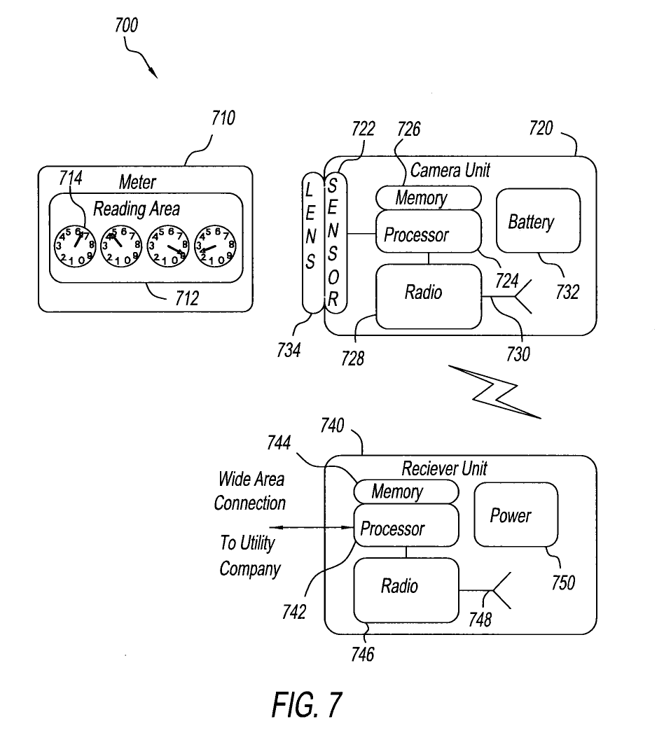

In another embodiment, referring to FIG. 7, an automated meter reading system is illustrated. System 700 generally comprises an imaging camera unit 720 attached to or otherwise coupled to a meter 710. In one arrangement, the camera includes a lens or lens system and a CCD or CMOS imager. From time to time, camera unit 720 takes an image of the reading area 712 of meter 710. Reading area 712 has dials, such as dial 714, or a digital display for presenting utility usage information. The image is captured by camera unit 720, and communicated back to a receiver unit 740. In one example, receiver unit 740 is a handheld device used by a human meter reader. In this way, a person driving in a vehicle or walking a distance away from the meter can remotely and wirelessly read the meter. In another example, the receiver unit is in the residential or commercial unit for meter 710, and wirelessly receives image data. The image data may then be communicated through a wide area connection back to the utility company. In another example, the receiver unit may be a centrally located receiver or hub communicating to a network of camera units. It will be appreciated that the communication processes operating between camera unit and the receiver unit 740 may be determined by the physical, electrical, and application requirements for each installation.

Advantageously, camera unit 720 may be configured to take meter readings as often as required or desirable for the utility company. For example, meter 710 may be read several times a day to assess peak utility usage. Also, the image of reading area 712 is a precise, accurate record of the reading, so any billing disputes may be immediately addressed. In one example, an image of reading area 712 may be included with a consumer bill for verification of accurate reading. As will be described below, camera unit 720 operates as a very low power imaging system. In this way, camera unit 720 operates particular network protocols for reducing power consumption. By conserving power, camera unit 720 may operate on battery 732 for several years. Since camera unit 720 may operate autonomously for years without maintenance, and provides an accurate, timely, and efficient way of reading legacy analog or digital meters, meter reading system 700 may be advantageously deployed for existing residential and commercial applications.

One example of camera unit 720 is described. Camera unit 720 has a small and compact housing for enclosing and protecting camera components. Camera unit 720 includes an imaging sensor 722 for capturing images of a meter dials or displays. The sensor may be, for example, a CMOS imager sensor for reduced power consumption, or may employ CCD imaging technology. It will be appreciated that other evolving technologies may be used to implement the sensor. The sensor may also be constructed to capture visible wavelength information, or may be set to detect other wavelengths, such as infrared. The sensor cooperates with a lens 734 to obtain the correct size and resolution of the image to facilitate automated or manual interpretation of the image. It will be appreciated that the resolution should be selected high enough to support the intended automated detection processes, if used. It will also be understood that the resolution needed will depend on dial or digit size, distance to the meter reading area, quality of lens, and other application characteristics. Of course, better resolution may support simplified and more accurate reading, but will also require more power to take and transmit the image. One skilled in the art will understand the tradeoffs and compromises between resolution, automated recognition, and power consumption. Camera unit 720 also has processor 724 for providing control and processing capability to the camera unit. For example, processor 724 may be constructed to configure and control sensor 722. In another example, processor 724 may apply image processing to captured images, for example, to compress, recognize, or encrypt image data. In one specific example, processor 724 applies a JPEG compression algorithm to images captured by sensor 722 to reduce file size while maintaining image quality.

Processor 724 may also implement network control settings and processes. For example, network control settings may define how often the camera attempts to communicate with a receiver 740, or settings regarding encryption or compression. Further, network control settings may include a unique ID for the camera 720. The unique ID may be used to associate the camera with a particular meter, and thereby be used by an accounting process to automatically and confidently assure that the proper entity is billed. In this way, a unique association is made between particular meter data and the party-to-be billed. The unique ID also enables a receiver 740 to be associated with a particular camera, which may be a hub or another camera. Camera 720 also has camera control settings. These camera control settings may set integration times for sensor 722, define capture windows, or define timing and sequential information regarding image capture.

In providing the various functions, processor 724 cooperates with local memory 726. Local memory 726 provides storage space for images captured by sensor 722, as well as memory space for application and algorithmic processes performed by processor 724. Camera 720 is intended for discrete installation, as well as long-term operation without any required maintenance. This includes for example remote operation relying fully on battery 732 for power. It will be appreciated that as battery technology advances, additional gains in battery life may be expected.

Battery 732 life is extended by having the camera normally operate in a sleep mode, and only activating the camera for necessary periods of time. More specifically, camera 720 normally operates in a sleep mode where radio 728 is deactivated. Further, except as discussed below, processor 724 is also deactivated. In sleep mode, the processor 724 is deactivated except for a low power timer. This low power timer draws in the range of 5 to 10 micro amps of power. The low power timer may be set to generate an interrupt at a set time or on a periodic basis. It will be understood that the resolution and stability of the clock may be selected according to application needs. For example, some asynchronous communication processes may benefit from a relatively inaccurate and unstable clock, while a synchronous system may need a better resolution clock. When the low power timer generates an interrupt signal, an interrupt activates radio 728 as well as processor 724. The camera, now being activated, acts according to its defined network controls and its camera controls. In one specific example, when the camera first wakes up, it generates a request signal through radio 728, which is transmitted by antenna 730.

After the request signal has been transmitted, the radio 728 enters a listen mode for a defined short period of time. For example, this listen mode may be opened for 20 ms to 50 ms. During this listen mode, the camera 720 is waiting to receive an acknowledgment signal from a receiver, such as a hub or another camera. If no acknowledgment signal is received during the listen period, the camera 720 goes back to sleep, which may be for a programmable time period. If however, the receiver 740 does respond, then the receiver 740 may command the camera 720 to take an action. These actions could include, to take an image, to transmit a stored image, or to go back to sleep. Of course, the camera power requirements increase dramatically while radio 728 and processor 724 are operating. However, the radio and processor operate for only a short period of time, so the overall drain is not substantial. Accordingly, it will be recognized that overall battery life is highly dependent on how often the low power timer causes the camera to wake up. For example, if the node camera 720 is set to wake up and transmit its request signal once every 10 minutes, then the battery life may extend for a certain period of time. More frequent wake ups will result in a shorter battery life. It will be understood that the image can be transmitted immediately after taken or stored as a data file in the processor for later transmission, depending on the communication protocol. Each image may have a time stamp as part of the information field.

Both the camera unit 720 and the receiver unit 740 include radio transceivers to enable two way communications and power-conserving networking protocols, as required by the network. Receiver unit 740 is constructed to wirelessly communicate with one or more camera units, such as camera unit 720. The receiver unit 740 has a two-way radio system 746 with antenna 748 constructed to cooperate with radios in the camera units. The receiver unit also has a processor 742 and memory 744 for performing network, control, or algorithmic processes. The receiver unit has a power source 750, which in some cases may be a persistent source such as a connection to a utility power grid. In other cases, power 750 may be from a battery or rechargeable battery. For example, if receiver unit 740 is an 802.11 access point in a residential home, then the receiver unit 740 is likely powered by connection to household power. In another example, if receiver unit 740 is a handheld portable device, then power 750 may be a rechargeable battery. In yet another example, receiver unit 740 may be another camera, in which case power 750 will be a regular battery. It will be appreciated that the type and speed of the processor and the sophistication of applications operating on the receiver unit 740, may in part be determined by the type of power available.

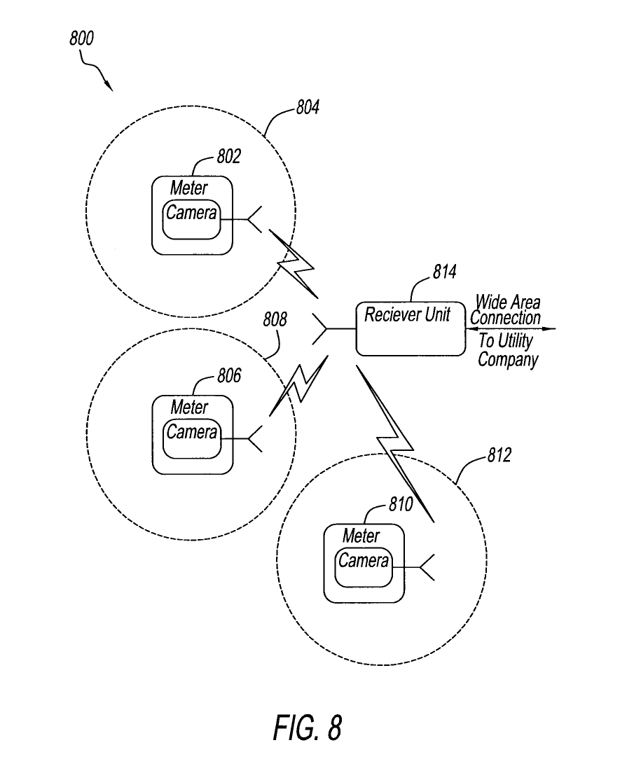

Referring now to FIG. 8, a meter reading arrangement is illustrated. Arrangement 800 has multiple camera units, such as camera unit 720 described with reference to FIG. 7. Each camera unit is located in a particular geography, such as at the service entrance for a residential house, a commercial building, or an industrial site. In FIG. 8, camera/meter 802 is located on house 804, camera/meter 806 is located on house 808, and camera/meter 810 is located on house 812. Each camera 802, 806, and 810 is configured to communicate wirelessly with receiver unit 814. Receiver unit 814 has a wide area connection to a utility company. In one example, receiver unit 814 is a central hub operated by the utility company. The receiver unit 814 operates an asynchronous network for controlling and receiving image data from each of the cameras. From time to time, the receiver unit 814 communicates meter reading data to the utility company. In another example, receiver unit 814 may be a portable receiver carried by a human meter reader or positioned in a utility company vehicle. In this way, the portable reader may be brought within a few hundred feet of meters, and meters automatically and wirelessly read as the receiver unit 814 moves down the street. In this way, a meter reader does not have to gain access to private areas of the house, but merely has to pass by on the public sidewalk or street areas. A portable receiver unit 814 may have a wireless connection back to the utility company, or may locally store data and then be connected to utility company servers at a later time.

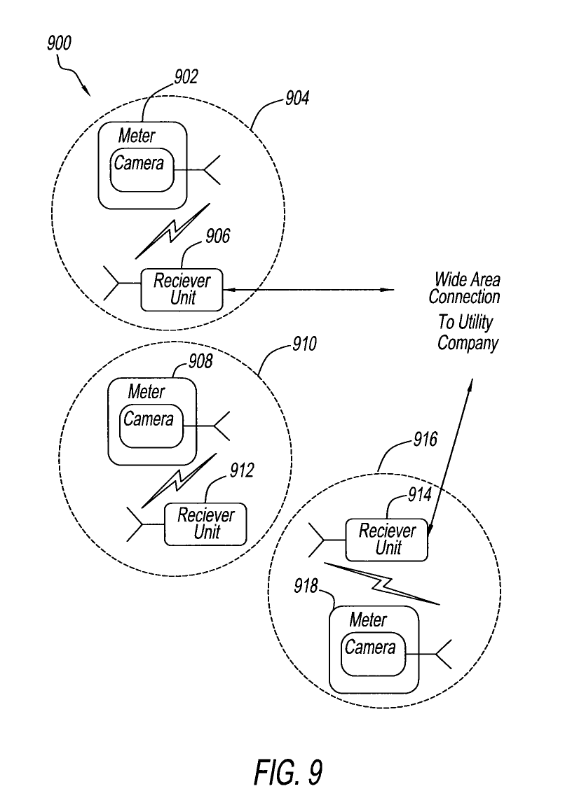

Referring now to FIG. 9, another arrangement 900 is illustrated. Arrangement 900 has camera/meter unit 902 located at house 904, camera/meter unit 908 located at house 910, and camera/meter unit 918 located at house 916. Each house has a receiver unit associated with it. For example, house 904 has receiver unit 906, house 910 has receiver unit 912, and house 916 has receiver unit 914. It will be appreciated that although the geographic areas of FIG. 9 are illustrated with reference to residential homes, the geographic areas may be residential apartments, commercial establishments, or industrial facilities. It will also be understood that the geographic areas may be meter areas within a single manufacturing facility. For example, the geographic areas may represent an array of meters supporting manufacturing equipment, or may be an array of meters in a utility room. The receiver units 906, 912, and 914 may be, for example, constructed to operate according to 802.11 protocols. In such a case, the associated cameras would also operate according this protocol, and enable simple communication between cameras and receiver units. In one specific example, the receiver units are also configured as Internet access points. In this way, each receiver unit has wide area connection to the utility company through an Internet connection. In this arrangement, each receiver unit obtains image information from its associated camera through an 802.11 communication, and then communicates meter data via the Internet to the utility company. This has the advantage of using existing communication modes and equipment for communication, but uses equipment not under the control of the utility company. Accordingly, receiver units may alternatively be constructed as proprietary equipment under the control of the utility company.

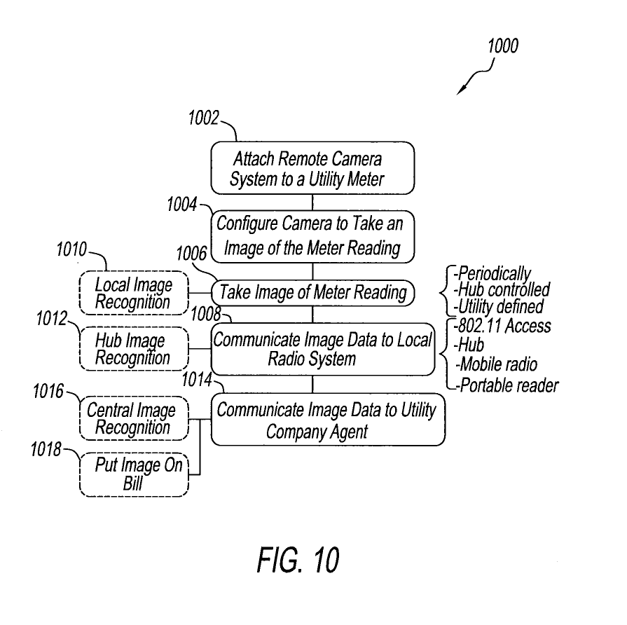

Referring now to FIG. 10, a system 1000 for reading a meter is illustrated. In system 1000 a remote camera system is attached to a meter as shown in block 1002. For example, the meter may be attached or strapped to the outside of the meter housing, or may be positioned within the meter case itself. It will be appreciated that the attachment of a camera to a meter can use any of several know attachment devices or adhesives. The camera is configured to take an image of the meter as shown in block 1004. For example, the camera may have one or more lenses in front of its sensor that enable the meter dials or digits to be captured with sufficient resolution to be automatically or manually deciphered. Also, the camera may have an associated lamp or lighting system for illuminating a dark meter. This lamp system may be augmented with an ambient light detection system, which illuminates the lamp only when ambient light is not sufficient. In one example, the imager itself is used to detect the level of ambient light, and responsive to unacceptably low contrast, will illuminate a lamp. In this way, the power cost of operating a lamp is only expended when necessary.

The camera then takes an image of the meter dial or digits as shown in block 1006. This image may be taken periodically according to an internal clock in the camera system, or may be set or adjusted by a central controller such as a hub. In another example, the timing of the images may be defined by the utility, and communicated to the camera through a hub or other receiver. In this way, a utility may require faster rates of images during peak usage times, while allowing fewer images during off usage periods. Optionally, the image may be processed locally for image character recognition as shown in block 1010. The image data is then wirelessly communicated to a local radio system as shown in block 1008. This local receiver may be for example, a local IEEE 802.11 access point, a receiver or hub, a mobile radio, or a portable reader. It will be appreciated that several configurations of the radio system may be used. Since the local radio system may have additional power and processing capability, it may optionally be able to do character recognition as shown in block 1012. The meter image data, whether raw image or processed data, is then communicated to the utility through a wide area connection as shown in block 1014. This wide area connection may be another wide area wireless system, or may be through a connected network such as the Internet.

The central office then may perform central image recognition as shown in block 1016, and may also put the image on the bill 1018 for reference. The utility is then able to advantageously use the meter data for preparing timely and accurate bills. It will also be understood that the camera system may send only change information in its images. In this regard, the imager may from time to time take a reference frame of the meter dial, and thereafter send only the differences between the reference frame and the current frame. Although this requires some additional processing at the camera, such processing is relatively simple, and may reduce substantially the amount of time necessary to operate the radio. Since the radio is a relatively high power device, performing such comparison on the local radio may net cause usage of less power.

In accordance with the method of this disclosure, one or more predictive models are generated based at least in part on the first set of information from the utility provider entity and the second set of information from the financial transaction processing entity. Predictive models can be selected based on the information obtained and stored in the one or more databases. The selection of information for representation in the predictive models can be different in every instance. In one embodiment, all information stored in each database can be used for selecting predictive models. In an alternative embodiment, only a portion of the information is used. The generation and selection of predictive models may be based on specific criteria.

Predictive models are generated from the information obtained from each database. The information is analyzed, extracted and correlated by, for example, a financial transaction processing company (e.g., a payment card company), and can include utility and financial account information, performing statistical analysis on utility and financial account information, finding correlations between account information and consumer behaviors, predicting future consumer behaviors based on account information, relating information on utility and financial accounts with other utility and financial accounts, or any other method of review suitable for the particular application of the data, which will be apparent to persons having skill in the relevant art.

The predictive models can be useful to leverage the information available, for example, in trading and investing in weather or other natural event derivatives. The trading or investing in weather or other natural event derivatives based on the one or more predictive models can be part of a risk management strategy to reduce risk associated with adverse or unexpected weather conditions or other natural events.

The predictive models can be useful to leverage the information available to identify data that is indicative of a customer's activities and characteristics and to predict consumer behavior and intent based on those activities and characteristics, e.g., energy conservation, water conservation, green practices and sustainable lifestyle practices of customers, and the like.

Predictive models can be defined based on geographical or demographical information, including but not limited to, age, gender, income, marital status, postal code, income, spending propensity, and familial status. In some embodiments, predictive models can be defined by a plurality of geographical and/or demographical categories.

In an embodiment, the information retrieved from each of the databases can be analyzed to determine behavioral information of the utility customer. Also, information related to an intent of utility customer can be extracted from the behavioral information. The predictive models can be based upon the behavioral information of the utility customers and the intent of the utility customers. The predictive models can be capable of predicting behavior and intent of the utility customers.

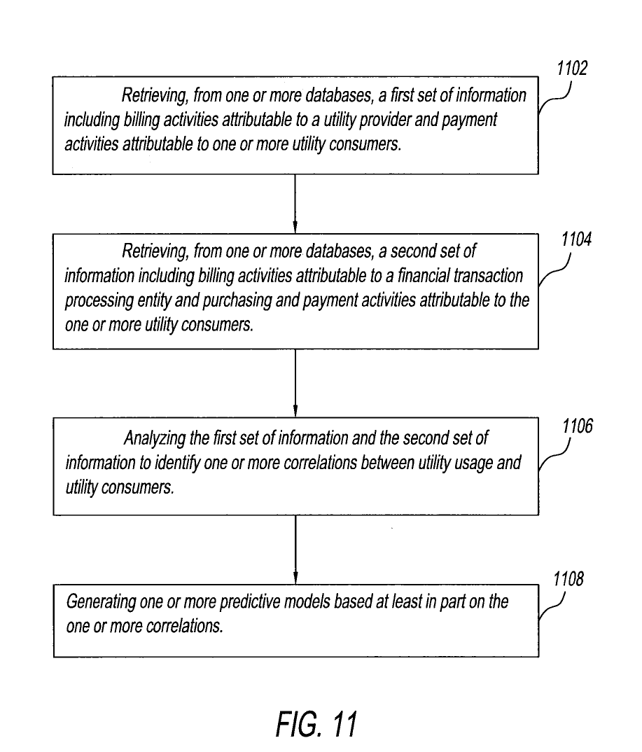

A method for generating one or more predictive models is an embodiment of this disclosure. Referring to FIG. 11, the method involves retrieving at 1102, from one or more databases, a first set of information including billing activities attributable to a utility provider and payment activities attributable to one or more utility consumers. The information at 1102 comprises utility provider billing, utility consumer payment transactions, and optionally demographic and/or geographic information. The method further involves retrieving at 1104, from one or more databases, a second set of information including billing activities attributable to a financial transaction processing entity (part of the payment card company network 150 in FIG. 1) and purchasing and payment activities attributable to the one or more utility consumers. The information at 1104 comprises financial transaction processing entity billing, utility consumer payment transactions, and optionally demographic and/or geographic information. At 1106, the first set of information and the second set of information are analyzed to identify correlation information of utility usage and utility consumers. One or more predictive models are generated at 1108 based at least in part on the correlation information.

In accordance with the method of this disclosure, information that is stored in one or more databases may be retrieved (e.g., by a processor). The information can contain, for example, a first set of information including billing activities attributable to the utility provider and payment activities attributable to the consumer (e.g., customers or subscribers of the utility provider). Illustrative first set information can include, for example, financial (e.g., billing statements), demographic (e.g., age and gender), geographic (e.g., zip code and state or country of residence), and the like. Also, the information can contain, for example, a second set of information including billing activities attributable to the financial transaction processing entity (e.g., a payment card company) and purchasing and payment activities attributable to the utility customers (e.g., payment card holders). Illustrative second set information can include, for example, financial (e.g., billing statements and payments), purchasing information, demographic (e.g., age and gender), geographic (e.g., zip code and state or country of residence), and the like.

In an embodiment, all information stored in each database can be retrieved. In another embodiment, only a single entry in each of the one or more databases can be retrieved. The retrieval of information can be performed a single time, or may be performed multiple times. In an exemplary embodiment, only information pertaining to a specific predictive model is retrieved from each of the databases.

Other card holder attributes part of the information can include, for example, geography (e.g., zip code, state or country), and demographics (e.g., age, gender, etc.).

While we have shown and described several embodiments in accordance with our disclosure, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A method of billing a consumer for utility usage, said method comprising:
providing a camera or imaging device optionally coupled to a utility meter at a consumer site, wherein the camera or imaging device operates to provide one or more wireless meter reading images of the utility meter from time to time, and wherein the one or more wireless meter reading images comprise utility usage data and identifying data of said utility meter;
transmitting the one or more wireless meter reading images to the utility provider; and
receiving from the utility provider a billing statement for utility usage at the consumer site for a defined time period, said billing statement based on the one or more wireless meter reading images transmitted to the utility provider.

2. The method of claim 1, further comprising:
verifying that the billing statement accurately reflects the utility usage at the consumer site for the defined time period

3. The method of claim 2, further comprising:
if a discrepancy exists between the billing statement and utility usage at the consumer site for the defined time period, requesting the utility provider to adjust the billing statement to accurately reflect the utility usage at the consumer site for the defined time period, based on the one or more wireless meter reading images transmitted to the utility provider.

4. The method of claim 1, wherein the consumer is a payment card holder.

5. The method of claim 4, further comprising:
conducting a payment card transaction between the consumer and the utility provider for a full or partial amount of the billing statement for utility usage at the consumer site for the defined period.

6. The method of claim 1, wherein the billing statement includes a copy of the one or more meter reading images transmitted to the utility provider.

7. The method of claim 1, wherein said at least one utility meter comprises at least one of an electric meter, a gas meter, and a water meter.

8. The method of claim 1, wherein said at least one camera or imaging device comprises at least one of a wireless cell phone, a digital camera, a web camera, a smartphone, a tablet computer, and a netbook computer.

9. The method of claim 1, wherein said at least one camera or imaging device comprises:
a housing; and
a lens, a memory, a processor, a power source, and a wireless communication transceiver associated with the housing;
wherein the camera or imaging device is adapted to be connected to the utility meter.

10. The method of claim 9, wherein said power source comprises at least one of a battery, a solar power panel, a wind turbine, and a portion of power supplied to said at least one utility meter.

11. The method of claim 9, wherein the wireless communication transceiver operates according to 802.11, a WiFi network, a Code Division Multiple Access (CDMA) network, a Global System for Mobile Communications (GSM) network, or a specialized wireless protocol.

12. A method comprising:
retrieving, from one or more databases, a first set of information including billing activities attributable to a utility provider and payment activities attributable to one or more utility consumers;
retrieving, from one or more databases, a second set of information including billing activities attributable to a financial transaction processing entity and purchasing and payment activities attributable to said one or more utility consumers;
analyzing the first set of information and the second set of information to identify one or more correlations between utility usage and utility consumers; and
generating one or more predictive models based at least in part on the one or more correlations.

13. The method of claim 12, wherein the one or more utility consumers are payment card holders and the billing statement is paid with a payment card.

14. The method of claim 12, wherein at least part of the first set of information is generated by:
providing a camera or imaging device optionally coupled to a utility meter at a consumer site, wherein the camera or imaging device operates to provide one or more wireless meter reading images of the utility meter from time to time, and wherein the one or more wireless meter reading images comprise utility usage data and identifying data of said utility meter;
transmitting the one or more wireless meter reading images to the utility provider; and
receiving from the utility provider a billing statement for utility usage at the consumer site for a defined time period, said billing statement based on the one or more wireless meter reading images transmitted to the utility provider.

15. The method of claim 12, wherein at least part of the second set of information is generated by:
conducting a payment card transaction between the one or more utility consumers and the utility provider for a full or partial amount of the billing statement for utility usage at the consumer site for the defined period.

16. The method of claim 12, further comprising:
trading or investing in weather derivatives based on the one or more predictive models.

17. The method of claim 16, wherein the trading or investing in weather derivatives based on the one or more predictive models is part of a risk management strategy to reduce risk associated with adverse or unexpected weather conditions.

18. The method of claim 12, further comprising:
identifying activities and characteristics attributable to said one or more utility consumers based on the one or more predictive models.

19. The method of claim 18, wherein the activities and characteristics comprise energy conservation, water conservation, green practices, and/or sustainable lifestyle practices.

20. The method of claim 14, wherein the billing statement includes a copy of the one or more meter reading images transmitted to the utility provider.

21. The method of claim 12, wherein the retrieving of the first set of information and the retrieving of the second set of information are from the same one or more databases.

22. The method of claim 14, wherein the utility meter comprises at least one of an electric meter, a gas meter, and a water meter.

23. The method of claim 14, wherein said at least one camera or imaging device comprises at least one of a wireless cell phone, a digital camera, a web camera, a smartphone, a tablet computer, and a netbook computer.

24. The method of claim 14, wherein said at least one camera or imaging device comprises:
a housing; and
a lens, a memory, a processor, a power source, and a wireless communication transceiver associated with the housing;
wherein the camera or imaging device is adapted to be connected to the utility meter.

25. The method of claim 24, wherein said power source comprises at least one of a battery, a solar power panel, a wind turbine, and a portion of power supplied to said at least one utility meter.

26. The method of claim 24, wherein the wireless communication transceiver operates according to IEEE 802.11, a WiFi network, a Code Division Multiple Access (CDMA) network, a Global System for Mobile Communications (GSM) network, or a specialized wireless protocol.
